(19) United States
(12) Patent Application Publication
(10) Pub. No.: US 2026/0074526 A1
(43) Pub. Date: Mar. 12, 2026

(54) POWER CONVERSION SYSTEM WITH VIRTUAL INVERTER BLOCK

(71) Applicant: EPC Power Corporation, Poway, CA (US)

(72) Inventors: David Michaud, Poway, CA (US); Christopher Lee, Poway, CA (US); William Giewont, Poway, CA (US); Devin Dilley, Poway, CA (US)

(73) Assignee: EPC Power Corporation, Poway, CA (US)

(21) Appl. No.: 19/007,402

(22) Filed: Dec. 31, 2024

Related U.S. Application Data
(60) Provisional application No. 63/691,777, filed on Sep. 6, 2024.

(51) Int. Cl. H02J 3/46; H02M 7/493

(52) U.S. Cl. CPC H02J 3/46; H02M 7/493; H02J 2101/24

(57) ABSTRACT

A control system can include one or more processors. The one or more processors can detect an electrical coupling between terminals of at least two power converter units of a plurality of power converter units, generate a virtual converter block that can include the at least two power converter units, and control operation of the at least two power converter units based on aggregate characteristics of the virtual converter block.

### CROSS-REFERENCE TO RELATED PATENT APPLICATIONS

This application claims the benefit of and priority to U.S. Provisional Patent Application No.: 63/691,777, filed Sep. 6, 2024, the entirety of which is incorporated by reference herein.

### BACKGROUND

Renewable energy sites include solar panels and various electrical components including inverters to produce electrical power from sunlight.

### SUMMARY

At least one embodiment relates to a power conversion system comprising. The power conversion system can include a plurality of power converter units. Each power converter unit of the plurality of power converter units can receive direct current (DC) power from one or more power sources. Each power converter unit can convert the DC power into alternating current (AC) power. The power conversion system can include a control system. The control system can include one or more processors. The one or more processors can detect electrical coupling between terminals of at least two power converter units of the plurality of power converter units. The one or more processors can generate a virtual converter block comprising the at least two power converter units. The virtual converter block can represent a combined AC power output of the at least two power converter units. The one or more processors can control operation of the at least two power converter units based on aggregate characteristics of the virtual converter block.

At least one embodiment relates to a method. The method can include receiving, at a computing system, operational data from a plurality of power converter units electrically coupled to one or more power sources. The method can include detecting, by one or more processors of the computing system, that at least two power converter units of the plurality of power converter units share electrically coupled terminals. The method can include generating, by the one or more processors, a virtual converter block that represents a combination of the at least two power converter units. The method can include monitoring, by the one or more processors, aggregate performance characteristics of the virtual converter block. The method can include controlling, by the one or more processors, operation of the at least two power converter units based on the aggregate performance characteristics.

At least one embodiment relates to a control system. The control system can be for power conversion. The control system can include one or more processors. The control system can include memory that can store instructions. The instructions can, when executed by the one or more processors, cause the control system to monitor operational parameters of multiple power converter units. The instructions can cause the control system to detect electrical coupling between at least two power converter units of the multiple power converter units. The instructions can cause the control system to create a virtual converter block representing the at least two power converter units as a single logical unit. The instructions can cause the control system to track aggregate performance metrics for the virtual converter block. The instructions can cause the control system to generate control commands for the at least two power converter units based on the aggregate performance metrics.

### BRIEF DESCRIPTION OF THE DRAWINGS

FIG. 1 is a block diagram of a system to generate a virtual inverter block, according to some embodiments.

FIG. 2 is a block diagram of the system of FIG. 1, according to some embodiments.

FIG. 3 is a table illustrating outputs of a first inverter and a second inverter, according to some embodiments.

FIG. 4 is a flow diagram of a process to generate a virtual inverter block, according to some embodiments.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Systems and methods to generate virtual inverter blocks for power conversion systems are described herein. Power conversion systems and/or power converter units (e.g., inverters, converters, rectifiers, etc.) are vital components for renewable energy sites (solar farms, wind farms, etc.) as the power converter units provide important functionality such as the conversion and/or the storage of energy produced at the renewable energy sites. For example, inverters may be coupled with solar panel arrays to convert direct current (DC) power, produced by the solar panel arrays, into alternating current (AC) power for distribution to power various devices and/or for generation of power onto power distribution systems or transmission systems. Stated otherwise, the inverters may provide AC power to the electric grid and/or power systems.

Power converter units often have fixed capacity amounts. For example, an inverter may include a power capacity and/or limit (e.g., how many watts the inverter may produce). As another example, an inverter may include a maximum voltage capacity (e.g., how much voltage the inverter may receive, how much voltage the inverter may produce, etc.). As even another example, an inverter may include a maximum current value (e.g., how much current the inverter may receive, etc.). Accordingly, to increase an overall capacity and/or output of a power conversion system multiple inverters of a power conversion system may be connected and/or otherwise stacked. Stated otherwise, the inverters may be coupled such that the power conversions system has an overall output (e.g., electrical energy, power, wattage, etc.) that is a combination of each inverter's individual capacity. As an example, two 400-watt inverters of a power conversion system, may be coupled such that an overall output of the power conversion system is 800 watts (e.g., the combination of each 400 watt inverter).

While inverters of a power conversion system may be coupled with one another, control strategies and/or performance monitoring is still performed as if the inverters are separate units. For example, control decisions for a first inverter are based on characteristics specific to the first inverter. Accordingly, while the outputs of multiple inverters may be combined, specific control decisions do not take into account the combined outputs.

Some technical solutions described herein include a system to generate a virtual inverter block. Advantageously, the virtual inverter block can represent a combination of outputs of multiple inverters such that a computing system may execute control decisions that account for each inverter within the virtual inverter block. Stated otherwise, the computing system may execute control decisions based on the combination of outputs. The virtual inverter blocks, described herein, may refer to and/or include a digital representation of multiple inverters. For example, the virtual inverter block may include software that emulates operation of multiple inverters.

The virtual inverter block can present information and/or data, to the computing system, that is indicative of cumulative operation of multiple inverters. For example, the virtual inverter block can present information that indicates a first power output of a first inverter and a second power output of a second inverter. In this example, the virtual inverter block can present the information as a combination (e.g., the first power output combined with the second power output). As another example, the virtual inverter block can present information specific to a given inverter such that computing system can monitor performance of the given inverter.

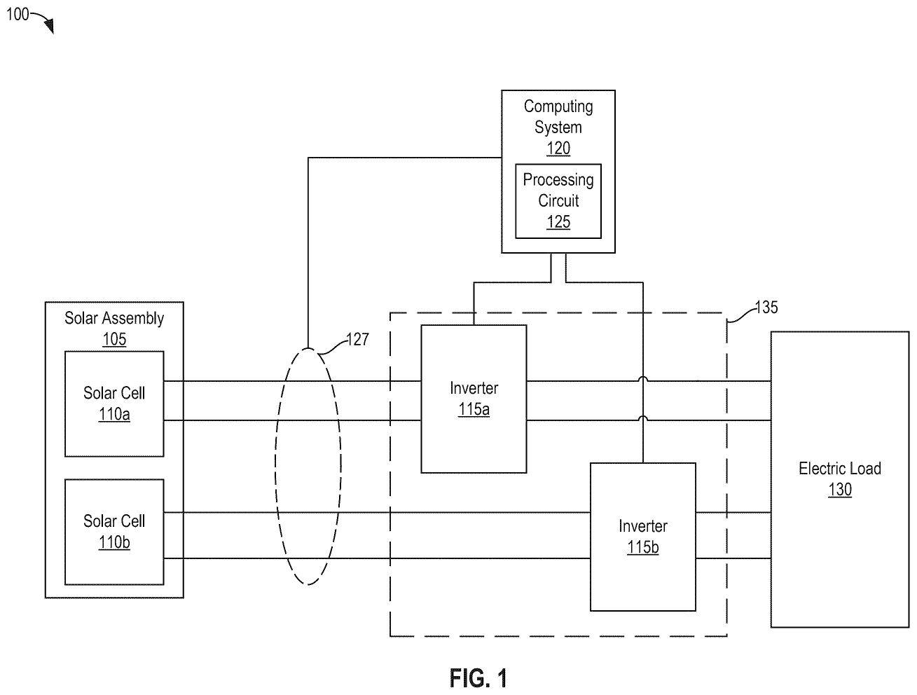

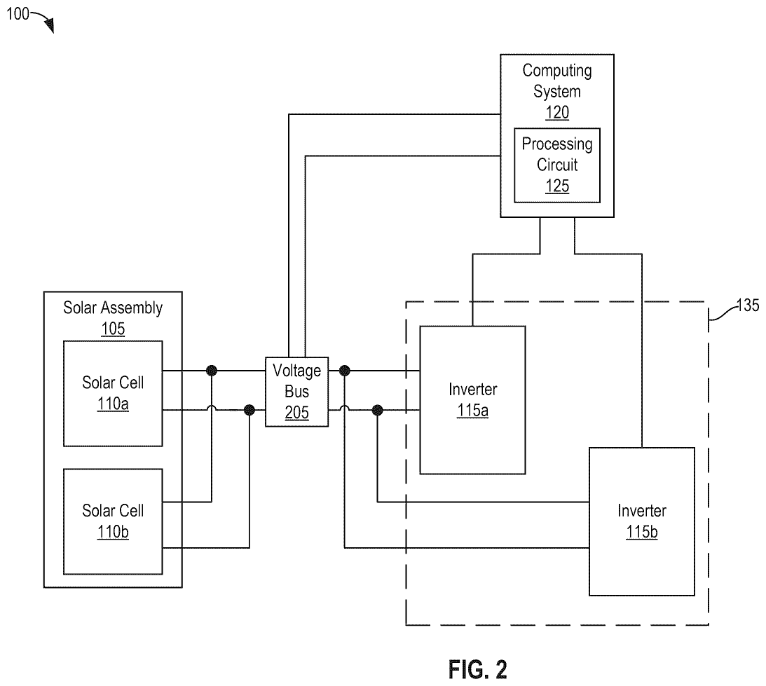

FIGS. 1-2 depict a block diagram of a system 100 to generate one or more inverter blocks, according to some embodiments. The system 100 and/or one or more components thereof may provide at least one of the technical solutions described herein. For example, the arrangement of one or more components of the system 100 may facilitate generation of a virtual inverter block. In some embodiments, one or more components of the system 100 may be electrical coupled and/or otherwise connected with one another such that a first component of the system 100 may provide electrical energy and/or power to one or more second components of the system 100. The system 100 may refer to and/or include at least one of a power conversion system, a power distribution system, and/or a power system.

As shown in FIG. 1, the system 100 includes a solar assembly 105, one or more inverters (shown as inverter 115a and 115b), a computing system 120, and an electric load 130. In some embodiments, the solar assembly 105 may include one or more solar panels and/or electrical devices, shown as solar cell 110a and solar cell 110b, to facilitate the capture, receipt, and/or conversion of solar energy. For example, the solar cells 110a and 110b may include one or more photovoltaic (PV) cells that may convert sunlight into electrical power (e.g., energy, electricity, etc.). As another example, the solar cells 110a and 110b may produce DC power. In some embodiments, the solar assembly 105 may be provided as a discrete and/or separate component to that of the system 100. For example, the solar assembly 105 may be added to and/or provided to renewable energy plant.

In some embodiments, the solar assembly 105 may be electrically coupled with one or more components and/or electrical circuitry of the system 100. For example, the solar assembly 105 (and/or the solar cells 110a and 110b) may be electrically coupled with at least one of energy storage devices, power converter devices, and/or other electrical circuitry of the system 100. In some embodiments, the solar assembly 105 may provide and/or otherwise forward electrical energy, converted from sunlight and/or solar energy, to provide electrical energy to power one or more components and/or devices of the system 100.

In some embodiments, the inverter 115a and/or the inverter 115b may facilitate the transfer and/or conversion of electrical power. For example, the inverter 115a may receive DC power, from the solar cell 110a, and convert the DC power to AC power. As another example, the inverter 115b may include step-up and/or step-down electrical circuitry such that the DC power, from the solar cell 110b, may be increased and/or decreased to facilitate the transfer of DC power to one or more components that operate on DC power. In some embodiments, the inverters 115a and 115b may produce AC power having one or more characteristics and/or properties. For example, the inverters 115a and 115b may produce single phase, two phase, three phase, and/or other phases of AC power.

In some embodiments, the inverters 115a and 115b may facilitate the transfer of electrical power by providing converted and/or adjusted electrical power (e.g., DC power converted to AC, DC to DC, AC to DC, etc.) to one or more components of the system 100. The inverters 115a and 115b may output and/or provide AC power that is single phase and/or a plurality of phases. As shown in FIG. 1, the inverters 115a and 115b are shown as electrically coupled with the electric load 130 such that the inverters 115a and/or 115b may provide AC power to the electric load 130. In some embodiments, the electric load 130 may refer to and/or include at least one of a consuming device, a power system, an electric grid, utility, and/or otherwise possible transmission systems. For example, the electric load 130 may represent an electric grid for which the inverters 115a and 115b provide and/or output AC power to.

In some embodiments, the inverter 115a and/or the inverter 115b may be electrically coupled with the solar assembly 105. For example, as shown in FIG. 1, the inverter 115a is electrically coupled with the solar cell 110a such that the inverter 115a can receive DC power from the solar cell 110a. As another example, as shown in FIG. 1, the inverter 115b is electrically coupled with the solar cell 110b such that the inverter 115b can receive DC power from the solar cell 110b. In some embodiments, the inverters 115a and 115b may receive DC power as the solar cells 110a and 110b capture and/or otherwise convert sunlight into DC power. Additionally and/or alternatively, the inverters 115a and 115b may receive DC power from the solar cells 110a and/or 110b continuously and/or semi-continuous.

In some embodiments, the inverter 115a and/or the inverter 115b may convert and/or otherwise adjust electrical power. For example, the inverter 115a may convert the DC power, received from the solar cell 110a, into AC power. As another example, the inverter 115b may adjust the DC power, received from the solar cell 110b, by increasing and/or decreasing a DC voltage provided by the solar assembly 105. In some embodiments, the inverters 115a and 115b may provide electrical power to one or more components of the system 100. For example, the inverter 115a may provide AC power and/or DC power to one or more components of the computing system 120. As another example, the inverter 115b may serve and/or act as electric source for the electric load 130 (e.g., the electric load 130 draws power from the inverter 115b).

In some embodiments, the computing system 120 may be electrically coupled with the inverter 115a and/or the inverter 115b such that the computing system 120 may monitor and/or evaluate operation and/or performance of the inverter 115a and/or the inverter 115b. For example, the computing system 120 may monitor one or more outputs (e.g., power, wattage, etc.) of the inverter 115a. As another example, computing system 120 may evaluate a conversion rate of the inverter 115b (e.g., differences and/or ratios between DC power provided to the inverter 115b and AC power produced by the inverter 115b).

As shown in FIG. 1, the computing system 120 includes a processing circuit 125. In some embodiments, the processing circuit 125 may include hardware, circuitry, firmware, software, etc. to facilitate and/or perform the various operations of the computing system 120. For example, the processing circuit 125 may include processors, coupled with memory, that execute one or more instructions stored in memory. As another example, memory may store executable code that, when executed by the one or more processors, causes the one or more processors to perform the operations of the computing system 120.

In some embodiments, the computing system 120 may refer to and/or include at least one of a mobile device, a tablet, a computer, a desktop, a cloud computing device, a monitor, a laptop, remote servers, remote database, and/or an interactive display device. Additionally, and/or alternatively, the computing system 120 may include one or more network devices, output devices, and/or programable devices. For example, the computing system 120 may include one or more of transmitters, transceivers, receivers, antennas, network jacks, network interface cards, or other devices to facilitate communication (e.g., telecommunication, electronic communication, web-based communication, etc.) between one or more devices. As another example, the computing system 120 may include a human-machine interface (HMI), a monitor, a display device, a dashboard device, a keyboard, a mouse, a dial pad, or other devices to receive and/or provide information. In some embodiments, the computing system 120 may include wired and/or wireless connections. For example, the computing system 120 may be wired (e.g., connected) to the inverter 115a via an interface of the computing system 120. As another example, the computing system 120 may facilitate wireless communication between a controller of the inverter 115a and a controller of the inverter 115b.

In some embodiments, the computing system 120 may facilitate communication between one or more external and/or remote devices. For example, the computing system 120 may facilitate communication with a mobile device and/or tablet such that information associated with operation of the inverters 115a and 115b may be provided to the mobile device. As another example, the computing system 120 may communicate with a power plant controller.

In some embodiments, the computing system 120 may be electrically coupled with one or more terminals and/or ports of the inverters 115a and 115b. For example, as shown in FIG. 1, dashed circle 127 illustrates the computing system 120 electrically coupled with lines and/or cords electrically coupling the solar cells 110a and 110b with the inverters 115a and 115b. In some embodiments, the computing system 120 may monitor, detect, evaluate, and/or otherwise determine the volage across the connections between the solar cell 110a and the inverter 115a. For example, the computing system 120 may determine an electrical potential and/or difference between a first terminal of the inverter 115a and a second terminal of the inverter 115b. As another example, the computing system 120 may monitor current values through the terminals and/or current values provided to the terminals.

In some embodiments, the computing system 120 may detect that the inverter 115a and the inverter 115b are electrically coupled with one another such that an output of the inverter 115a and an output of the inverter 115b are connected. For example, the computing system 120 may detect that the inverter 115a and the inverter 115b are both electrically coupled with the solar cell 110a and the solar cell 110b. As another example, the computing system 120 may detect that one or more output terminals of the inverter 115a are electrically coupled with one or more output terminals of the inverter 115b.

As shown in FIG. 2, the inverter 115a and the inverter 115b are shown electrically coupled with the solar cell 110a and the solar cell 110b via a voltage bus 205. For example, the solar cell 110a and the solar cell 110b can apply and/or provide a DC voltage to the voltage bus 205. In some embodiments, the inverter 115a and the inverter 115 can receive, via the voltage bus 205, the DC power provided by the solar cell 110a and the solar cell 110b. Stated otherwise, the voltage provided by the solar cell 110a and the solar cell 110b can be distributed to the inverter 115a and the inverter 115b.

In some embodiments, the computing system 120 may generate a virtual inverter block 135 and/or inverter block 135. For example, the computing system 120 can combine and/or otherwise associate the inverter 115a with the inverter 115b such that the computing system 120 interprets operation of the inverter 115a and the inverter 115b as a unitary and/or single component. Stated otherwise, the virtual inverter block 135 may represent a combination and/or aggregation of the inverter 115a and the inverter 115b. Additionally and/or alternatively, the computing system 120 may monitor operation of the inverter 115a and the inverter 115b with respect to the inverter block 135. For example, the computing system 120 can allocate and/or assign output metrics, commands, control signals, and/or output values (e.g., power, wattage, etc.) to the inverter block 135. To continue this example, the computing system 120 can partition or divide the output values between the inverter 115a and the inverter 115b such that the output values are shared. Stated otherwise, the computing system 120 can partition a first amount of the output values to the inverter 115a and a second amount of the output values to the inverter 115b.

In some embodiments, the computing system 120 can generate one or more control decisions based on the inverter block 135. For example, the computing system 120 can generate control decisions that adjust an output of the inverter 115a based on an output value assigned to the inverter block 135. As another example, the computing system 120 can adjust and/or modify output commands, assigned to the inverter 115a and the inverter 115b, based on the output value assigned to the inverter block 135. In some embodiments, the control decisions can include at least one of conversion rates, power output, wattage amounts, runtime, current amounts, and/or other possible electrical characteristics. For example, a first control decision can include the computing system 120 adjusting a level of AC power produced by the inverter 115a. As another example, a second control decision can include the computing system 120 dictating a given voltage level for AC power produced by the inverter 115b.

In some embodiments, the computing system 120 may monitor and/or detect signals and/or power transmitted to and/or from at least one of the terminals of the inverter 115a and the inverter 115. For example, the computing system 120 may monitor an amount of DC power output by the inverter 115a. As another example, the computing system 120 may monitor an aggregate amount of DC power, associated with the inverter block 135, by combining DC power output by the inverter 115a with DC power output by the inverter 115b.

While FIGS. 1 and 2 illustrate the system 100 as include the inverter 115a and the inverter 115b (e.g., two inverters), this is for illustrative purposes only and is in no way limiting. For example, the system 100 may include five inverters. As another example, the system 100 may include ten inverters. As even another example, the system 100 may include three or more inverters. Additionally and/or alternatively, the system 100 may include multiple virtual inverter blocks 135. For example, the system 100 may include four inverters. In this example, the system 100 may include two virtual inverter blocks that each include two of the four inverters. As another example, the system 100 may include twelve inverters. In this example, the system 100 may include four virtual inverter blocks that each include three inverters. Additionally and/or alternatively, the system 100 may include multiple and/or varying numbers of inverters and/or virtual inverter blocks.

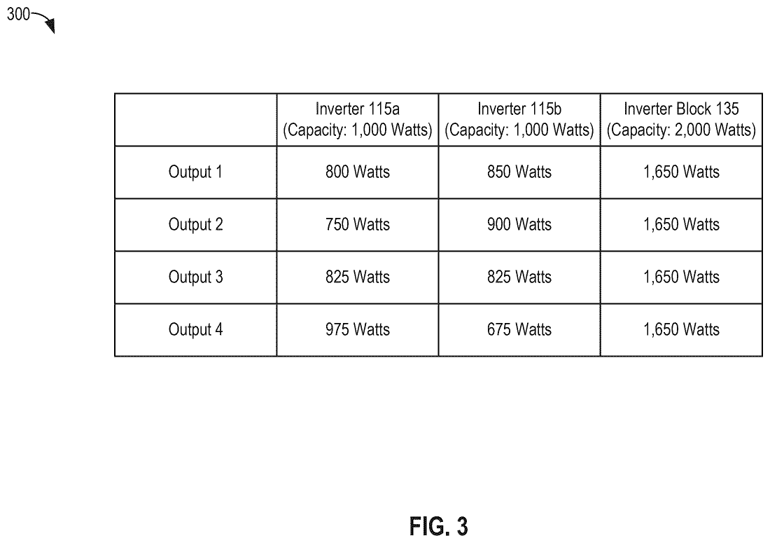

FIG. 3 depicts a table 300 that includes power outputs associated with the inverter 115a and the inverter 115b, according to some embodiments. As shown in FIG. 3, the inverter 115a and the inverter 115b are shown to have a capacity of 1,000 watts (e.g., a wattage rating, a wattage maximum, a wattage value, etc.). Additionally, in FIG. 3, the inverter block 135 is shown to have a capacity of 2,000 watts (e.g., a combination of the capacity of the inverter 115a and the capacity of the inverter 115b). While FIG. 3 may include given examples for capacities of various components, these examples are for illustrative purposes only and are in no way limiting.

As shown in FIG. 3, the table 300 includes multiple rows (shown as Output 1, Output 2, Output 3, and Output 4). In some embodiments, each row can represent operation (e.g., power conversion, power output, etc.) of the inverter 115a and the inverter 115b. For example, Output 1 can represent a conversion of power by the inverter 115a and a conversion of power by the inverter 115b.

As shown in FIG. 3, in Output 1, the inverter 115a is shown as outputting 800 watts and the inverter 115b is shown as outputting 850 watts. According, the inverter block 135 is shown as outputting 1,650 watts (e.g., a combination of the watts produced by the inverter 115a and the inverter 115b). In some embodiments, the electric load 130 may consume and/or demand wattage from the inverter block 135. Additionally and/or alternatively the electric load 130 may receive power from the inverter block 135. For example, the electric load 130 may include an electric grid and the inverter block 135 may output and/or provide power to the electric grid. In some embodiments, the computing system 120 may adjust and/or modify operation of the inverter 115a and/or the inverter 115b based on wattage produced by the inverters 115a and 115b. For example, in Output 2, the inverter 115a is shown as producing 750 watts. To continue this example, to ensure that the output of the inverter block 135 remains at 1,650 watts, the computing system 120 has controlled the inverter 115b such that the output of the inverter 115b has been increased to account for the decrease in wattage from the inverter 115a. As another example, a power output demand may be adjusted such that a demand, placed on the inverter block 135, aligns with the AC power (e.g., output) produced by the inverter block 135.

As another example, in Output 3, the computing system 120 has controlled the inverter 115a to output 825 watts to match the output produced by the inverter 115b. As another example, in Output 4, the computing system 120 has controlled the inverter 115a to output 975 watts to account for the output of the inverter 115b having dropped to 675 watts.

In some embodiments, the modification of the inverter 115a based on outputs of the inverter 115b and/or vice versa provides some of the technical solutions described herein. For example, the inverter block 135 provides for an overall output of a system to be determined and/or generated. The computing system 120 can monitor operation of the inverter 115a and the inverter 115b, relative to the inverter block 135, to detect whether a given inverter fall behinds. Absent the inverter block 135, output values would be assigned to inverters and the output of the inverters would be compared to the output values instead of the overall output of the inverter block 135.

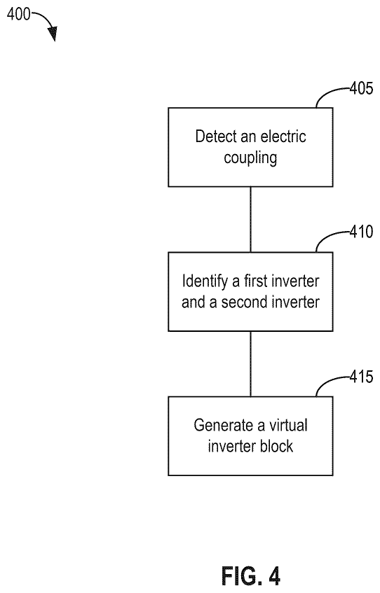

FIG. 4 depicts a flow diagram of a process 400 to generate a virtual inverter block, according to some embodiments. In some embodiments, at least one system, component, and/or device described herein may perform the process 400 and/or one or more steps thereof. For example, one or more components of the system 100 may be implemented to perform the process 400. In some embodiments, the process 400 and/or one or more steps thereof may be modified and/or changed such that one or more steps may be skipped, omitted, repeated, separated, combined, replicated, and/or otherwise altered. For example, a given step of the process 400 may be performed more than once. As another example, a first given step and a second given step of the process 400 may be combined into a single step.

In some embodiments, at step 405, an electric coupling may be detected. For example, the computing system 120 may detect that one or more terminals of the inverter 115a are electrically coupled with one or more terminals of the inverter 115b. As another example, the computing system 120 may detect that the inverter 115a and the inverter 115b are electrically coupled with the voltage bus 205. In some embodiments, the computing system 120 may detect the electric coupling by monitoring and/or detecting voltage levels at the voltage bus 205 and/or at one or more terminals. For example, the computing system 120 may detect the electric coupling between the inverter 115a and the inverter 115b based on an input voltage being the same for the inverter 115a and the inverter 115b.

In some embodiments, at step 410, a first inverter and a second inverter may be identified. For example, the computing system 120 may identify the inverter 115a as being electrically coupled with the inverter 115b. As another example, the computing system 120 may identify an arrangement of the inverters. Stated otherwise, the computing system 120 may identify if the inverters 115a and 115b are arranged in series and/or parallel relative to one another.

In some embodiments, at step 415, a virtual inverter block may be generated. For example, the computing system 120 may generate the inverter block 135 responsive to identification of the inverter 115a and the inverter 115b in step 410. In some embodiments, the inverter block 135 may include the inverter 115a and the inverter 115b. For example, the inverter block 135 may refer to and/or include a virtual and/or digital representation of the inverter 115a and the inverter 115b. As another example, the inverter block 135 may represent a combination of the inverter 115a and the inverter 115b. Stated otherwise, the inverter block 135 may represent a combination of power produced by the inverter 115a with power produced by the inverter 115b.

In some embodiments, the computing system 120 may control subsequent operation of the inverter 115a and the inverter 115b responsive to generation of the inverter block 135. For example, the computing system 120 may generate control decisions that cause an output of the inverter 115a to change from a first value to a second value. As another example, the computing system 120 may generate control decisions that cause the inverter 115b to produce an extra amount of wattage that accounts for a drop in wattage output by the inverter 115a.

### Configuration of Exemplary Embodiments

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed:

1. A power conversion system comprising:
a plurality of power converter units, wherein each power converter unit of the plurality of power converter units is configured to:
receive direct current (DC) power from one or more power sources; and
convert the DC power into alternating current (AC) power; and
a control system comprising one or more processors configured to:
detect electrical coupling between terminals of at least two power converter units of the plurality of power converter units;
generate a virtual converter block comprising the at least two power converter units, wherein the virtual converter block represents a combined AC power output of the at least two power converter units; and
control operation of the at least two power converter units based on aggregate characteristics of the virtual converter block.

2. The power conversion system of claim 1, wherein controlling operation of the at least two power converter units comprises:
monitoring a total power output of the virtual converter block; and
adjusting individual power outputs of the at least two power converter units to maintain the total power output at a target level.

3. The power conversion system of claim 1, wherein the one or more processors are further configured to:
detect a decrease in power output from a first power converter unit of the at least two power converter units; and
increase power output from a second power converter unit of the at least two power converter units to maintain a target power output level of the virtual converter block.

4. The power conversion system of claim 1, wherein detecting electrical coupling between terminals comprises detecting that the at least two power converter units are connected to a common voltage bus.

5. The power conversion system of claim 1, wherein the one or more processors are further configured to:
monitor individual performance metrics for each power converter unit within the virtual converter block; and
generate control decisions based on the individual performance metrics and aggregate performance metrics of the virtual converter block.

6. The power conversion system of claim 1, wherein the one or more power sources comprise a solar assembly including a plurality of solar cells configured to convert sunlight into DC power.

7. A method comprising:
receiving, at a computing system, operational data from a plurality of power converter units electrically coupled to one or more power sources;
detecting, by one or more processors of the computing system, that at least two power converter units of the plurality of power converter units share electrically coupled terminals;
generating, by the one or more processors, a virtual converter block that represents a combination of the at least two power converter units;
monitoring, by the one or more processors, aggregate performance characteristics of the virtual converter block; and
controlling, by the one or more processors, operation of the at least two power converter units based on the aggregate performance characteristics.

8. The method of claim 7, further comprising:
detecting, by the one or more processors, a change in power output from a first power converter unit of the at least two power converter units; and
automatically adjusting, by the one or more processors, power output from a second power converter unit of the at least two power converter units to compensate for the change.

9. The method of claim 7, wherein controlling operation comprises:
determining, by the one or more processors, a target power output level for the virtual converter block; and
distributing, by the one or more processors, the target power output level among the at least two power converter units.

10. The method of claim 7, wherein monitoring aggregate performance characteristics comprises:
combining, by the one or more processors, individual power outputs from each of the at least two power converter units; and
tracking, by the one or more processors, the combined power output as a single output metric.

11. The method of claim 7, further comprising:
identifying, by the one or more processors, individual capacity limits of each power converter unit within the virtual converter block; and
determining, by the one or more processors, an aggregate capacity limit for the virtual converter block based on the individual capacity limits.

12. A control system for power conversion, comprising:
one or more processors; and
memory storing instructions that, when executed by the one or more processors, cause the control system to:
monitor operational parameters of multiple power converter units;
detect electrical coupling between at least two power converter units of the multiple power converter units;
create a virtual converter block representing the at least two power converter units as a single logical unit;
track aggregate performance metrics for the virtual converter block; and
generate control commands for the at least two power converter units based on the aggregate performance metrics.

13. The control system of claim 12, wherein the instructions further cause the control system to:
receive power output data from each power converter unit within the virtual converter block; and
calculate total power output of the virtual converter block by combining individual power outputs.

14. The control system of claim 12, wherein generating the control commands comprises:
detecting that total power output of the virtual converter block deviates from a target level; and
adjusting individual power outputs of the at least two power converter units to achieve the target level.

15. The control system of claim 12, wherein the instructions further cause the control system to:
monitor voltage levels at terminals of the at least two power converter units; and
detect the electrical coupling based on matching voltage levels at the terminals.

16. The control system of claim 12, wherein the instructions further cause the control system to:
generate multiple virtual converter blocks, each virtual converter block comprising a different subset of the multiple power converter units.

17. The control system of claim 12, wherein tracking aggregate performance metrics comprises:
monitoring combined power output, efficiency, and conversion rates of the at least two power converter units as unified metrics for the virtual converter block.

18. The control system of claim 12, wherein the instructions further cause the control system to:
detect an addition of a new power converter unit to the electrical coupling; and
automatically incorporate the new power converter unit into the virtual converter block.

19. The control system of claim 12, wherein the instructions further cause the control system to:
monitor current flow between the at least two power converter units; and
adjust operation of individual power converter units based on the monitored current flow.

20. The control system of claim 12, wherein the multiple power converter units comprise inverters configured to convert DC power from solar cells into AC power for distribution to an electrical grid.
